(19) United States
(12) Patent Application Publication
(10) Pub. No.: US 2025/0380642 A1
(43) Pub. Date: Dec. 18, 2025

(54) SYSTEM AND METHOD FOR OPTIMIZING CROP FEEDING FOR SUGARCANE HARVESTER BASED ON CROP CONDITIONS AND HARVESTING SPEED

(71) Applicant: DEERE & COMPANY, Moline, IL (US)

(72) Inventors: Nikhil Chavan, Koregaon (IN); John A. Dighton, Napoleonville, LA (US)

(21) Appl. No.: 18/740,957

(22) Filed: Jun. 12, 2024

(51) Int. Cl. A01D 45/10; A01D 41/127

(52) U.S. Cl. CPC A01D 45/10; A01D 41/1274

(57) ABSTRACT

A sugarcane harvester and a method for harvesting a sugarcane crop having cane stalks. The sugarcane harvester includes a base cutter assembly configured to cut the cane stalks at a base and a header. The header includes a crop divider configured to position the cane stalks with respect to the sugarcane harvester, wherein the crop divider is rotatable about a divider rotational axis. A knockdown roller is configured to direct the positioned cane stalks to the base cutter assembly, wherein the knockdown roller is rotatable about a roller rotational axis. An imaging system is configured to provide crop information of the sugarcane crop and a controller is operatively connected to the imaging system. The controller is configured to receive the crop information, wherein the controller transmits one or more control signals in response to the crop information to one or both of the crop divider and the knockdown roller.

### FIELD OF THE DISCLOSURE

The present disclosure generally relates to a harvesting machine, and more particularly to systems and processes for harvesting sugarcane with a sugarcane harvesting machine.

### BACKGROUND

Agricultural equipment, such as a tractor or a self-propelled harvester, includes mechanical systems, electrical systems, hydraulic systems, and electro-hydraulic systems, configured to prepare fields for planting or to harvest crops.

Harvesters of various configurations, including sugarcane harvesters, have harvesting systems of various types. Harvesting systems for a sugarcane harvester, for example, include assemblies or devices for cutting, chopping, sorting, transporting, etc., and otherwise gathering and processing sugarcane plants. Typical harvesting assemblies, in different implementations, include a base cutter assembly (or “base cutter”), feed rollers, cutting drums, stalk collectors, and extractor fans etc.

To actively harvest crops, the sugarcane harvester gathers and processes material from rows of sugarcane plants. In the case of one type of sugarcane harvester, the gathered sugarcane stalks are cut into billets that move through a loading elevator to an elevator discharge, where the cut sugarcane billets are discharged to a collector, such as the sugarcane wagon. Leaves, trash, and other debris are separated from the billets and ejected onto the field.

In various harvesters, harvesting assemblies are hydraulically powered by an engine-driven pump or electrically powered by a generator or other electrical power supply. The harvesting assemblies include rotating drums that move the cut stalks toward a chopper. The rotating drums are driven by a hydraulic motor or an electric motor that rotationally drives the roller to continuously move the billets to a fan for processing, and once processed, to the wagon or other container. The motors include splines that engage the roller to drive the roller about a rotational axis.

The sugarcane, once cut, forms what is known as a “mat” of sugarcane. The sugarcane harvester feeds the mat to a chopping section where it is chopped, including the stalks which are cut into segments. The sugarcane harvester advances the chopped sugarcane mat, which includes billets and crop residue (e.g., leafy material, such as leaves, roots, and field debris etc.) to a primary extractor that separates at least a portion of the crop residue from the billets. The primary extractor includes a fan assembly having a motor and blades to clean the sugarcane, that is, to remove the crop residue from the sugarcane billets. The removed crop residue is discharged to the ground or to a collection wagon.

### SUMMARY

The present disclosure provides for efficient harvesting of sugarcane crop including a reduction in damage to or loss of sugarcane during a harvesting process. Control of the rotational speed of crop dividers, with respect to machine forward speed and crop conditions, such as the angle and direction of cane leaning, is provided. The rotational speed of crop dividers is controlled to ensure efficient lifting and to optimize aligning effects of sugarcane crop as a sugarcane harvester moves in a forward direction along a field. The control of the speed and position of knockdown rollers is also provided, which are controlled based on one or more of crop conditions, crop divider speeds, and harvester ground speeds. A sensing feedback system estimates the crop feed “quality” based on feedback received from pressure sensors, speed sensors, imaging devices, and cameras utilizing sensor fusion. As used herein, “quality” includes the acceptability of cut sugarcane that meets or exceeds a predetermined product standard. Improved customer value results from smooth feeding of sugarcane crop throughout the harvesting process with reduced sugarcane losses, reduced cane damage, and reduction or prevention of clogging that may occur at sugarcane feeding components.

In one implementation, there is provided a sugarcane harvester for harvesting a sugarcane crop having cane stalks. The sugarcane harvester includes a frame and a base cutter assembly coupled to the frame which is configured to cut the cane stalks at a base. A header is coupled to the frame. The header includes a crop divider configured to position the cane stalks with respect to the header, wherein the crop divider is rotatable about a divider rotational axis. A knockdown roller is coupled to the frame, wherein the knockdown roller is configured to direct the positioned cane stalk to the base cutter assembly and wherein the knockdown roller is rotatable about a roller rotational axis. An imaging system is configured to provide crop information of the sugarcane crop and a controller is operatively connected to the imaging system. The controller is configured to receive the crop information, wherein the controller transmits one or more control signals in response to the crop information to one or both of the crop divider and the knockdown roller.

In some implementations, the sugarcane harvester includes wherein the imaging system has an off-board imaging device configured to provide off-board image information of the sugarcane crop and an on-board imaging device to provide on-board image information of the sugarcane crop, wherein the off-board image information and the on-board image information are fused to provide the controller with a crop density.

In some implementations, the sugarcane harvester includes wherein the off-board image information and the on-board image information are fused to provide the controller with conditions of the cane stalk prior to being positioned by the crop divider.

In some implementations, the sugarcane harvester includes further includes one or more pressure sensors or one or more speed sensors operatively connected to one of or both of the crop divider or the knockdown roller, wherein each of the one or more pressure sensors provides pressure information and each the one or more speed sensors provides speed information.

In some implementations, the sugarcane harvester includes wherein the pressure information and the speed information is fused with the off-board image information and the on-board image information, and the fused information is transmitted to the controller to adjust operating conditions of the crop divider or the knockdown roller.

In some implementations, the sugarcane harvester includes wherein the one or more pressure sensors or one or more speed sensors are operatively connected to one of the basecutter or a chopper configured to cut the cane stalks into billets.

In some implementations, the sugarcane harvester includes wherein the crop information includes at least one of crop direction, alignment of the crop, and crop height.

In some implementations, the sugarcane harvester further includes a machine speed sensor coupled to the controller, wherein the controller receives a speed signal provided by the machine speed sensor and the controller adjusts a speed of the crop divider in response to the speed signal.

In some implementations, the sugarcane harvester further includes a crop feed flow sensor coupled to the controller, wherein the controller receives a crop feed flow signal provided by the crop feed flow sensor and the controller adjusts a speed of the crop divider in response to the crop feed flow signal.

In some implementations, the sugarcane harvester further includes a crop feed flow sensor coupled to the controller, wherein the controller receives a crop feed flow signal provided by the crop feed flow sensor and the controller adjusts a speed of the knockdown roller in response to the crop feed flow signal.

In another implementation, there is provided a crop flow system for a sugarcane harvester harvesting a sugarcane crop having cane stalks. The crop flow system includes a base cutter assembly configured to cut the cane stalks at a base of the cane stalks and a header. The header includes a cane topper, and a first crop divider spaced from a second divider, wherein each of the first crop divider and the second crop divider are driven about a respective rotational axis by crop divider drivers. A knockdown roller is configured to direct the cane stalk to the base cutter assembly, wherein the knockdown roller is located downstream of the crop dividers along a flow path and is rotatable about a roller rotational axis. Feed rollers are located downstream of the knockdown roller along the flow path and an imaging system is configured to provide crop information of the sugarcane crop. A controller is operatively connected to the imaging system and is configured to receive the crop information, wherein the controller transmits one or more control signals in response to the crop information to a divider driver of the first crop divider or the second crop divider to adjust a rotational speed thereof, and to a roller driver of the knockdown roller to adjust a roller speed thereof.

In some implementations, the crop flow system includes wherein the imaging system includes an on-board imaging device to provide on-board image information of the sugarcane crop and wherein the on-board image information is received by the controller to adjust the rotational speed of the first and second crop divider and the roller speed of the knockdown roller.

In some implementations, the crop flow system includes wherein the on-board imaging system includes an imaging device at the feed roller configured to transmit a feed roller imaging signal to the controller to identify a flow rate of sugarcane stalk along the flow path.

In some implementations, the crop flow system includes wherein the controller, in response to the identified flow rate, adjusts the rotational speed of the first and second crop divider and the roller speed of the knockdown roller.

In some implementations, the crop flow system includes wherein the controller, in response to the identified flow rate, adjusts a position of the knockdown roller.

In some implementations, the crop flow system further includes one or more pressure sensors or one or more speed sensors operatively connected to one of or both of the crop divider or the knockdown roller, wherein each of the one or more pressure sensors provides pressure information and each the one or more speed sensors provides speed information.

In some implementations, the crop flow system includes wherein the pressure information and the speed information is fused with the on-board image information, and the fused information is transmitted to the controller to adjust an operating condition of the crop divider or the knockdown roller.

In a further implementation, there is provided a method of adjusting a flow rate of harvested sugarcane crop moving through a sugarcane harvester during a harvesting operation of a sugarcane crop. The method includes: imaging the sugarcane crop with an onboard imaging system and with an off-board imaging system to provide sugarcane crop condition information of the sugarcane crop to be harvested, wherein the sugarcane crop information includes at least one of sugarcane crop density, sugarcane crop alignment, and sugarcane height information; identifying a divider rotational speed of a crop divider as the harvester harvests the sugarcane crop; identifying a roller rotational speed of a knockdown roller as the harvester harvests the sugarcane crop; identifying a crop flow of the harvested sugarcane along a crop flow path from the crop divider, to the knockdown roller, and to a feed roller; and adjusting at least one of the identified divider rotational speed or the identified roller rotational speed based on the sugarcane crop information and the identified crop flow.

In some implementations, the method further includes identifying a roller position of the knockdown roller and adjusting the roller position of the identified knockdown roller based on the sugarcane crop information and the identified crop flow.

In some implementations, the method further includes identifying an amount of crop lift provided by the identified rotational speed of the crop divider and adjusting one of the roller rotational speed and the roller position based on the amount of crop lift.

### BRIEF DESCRIPTION OF THE DRAWINGS

The above-mentioned aspects of the present disclosure and the manner of obtaining them will become more apparent and the disclosure itself will be better understood by reference to the following description of the implementations of the disclosure, taken in conjunction with the accompanying drawings, wherein:

FIG. 1 is a side view of a sugarcane harvesting machine;

FIG. 2 is a front view of a header of a sugarcane harvesting machine;

FIG. 3 is one implementation of a control system for a sugarcane harvester to harvest sugarcane;

FIG. 4 is one implementation of a control system to provide improved and optimized harvesting of sugarcane;

FIG. 5 is one implementation of a process for controlling spiral speeds of crop dividers;

FIG. 6 is one implementation of a process for controlling rotational speeds of knockdown rollers;

FIG. 7 is one implementation of a process for a working mechanism of the control logic for a crop feedback system; and

FIG. 8 is one implementation of process for optimizing crop feeding for a sugarcane harvester based on crop conditions and harvesting speed.

### DETAILED DESCRIPTION

For the purposes of promoting an understanding of the principles of the disclosure, reference will now be made to the implementations described herein and illustrated in the drawings and specific language will be used to describe the same. It will nevertheless be understood that no limitation of the scope of the disclosure is thereby intended, such alterations and further modifications in the illustrated devices, methods/processes, and such further applications of the principles of the disclosure as illustrated therein being contemplated as would normally occur to one skilled in the art to which the disclosure relates.

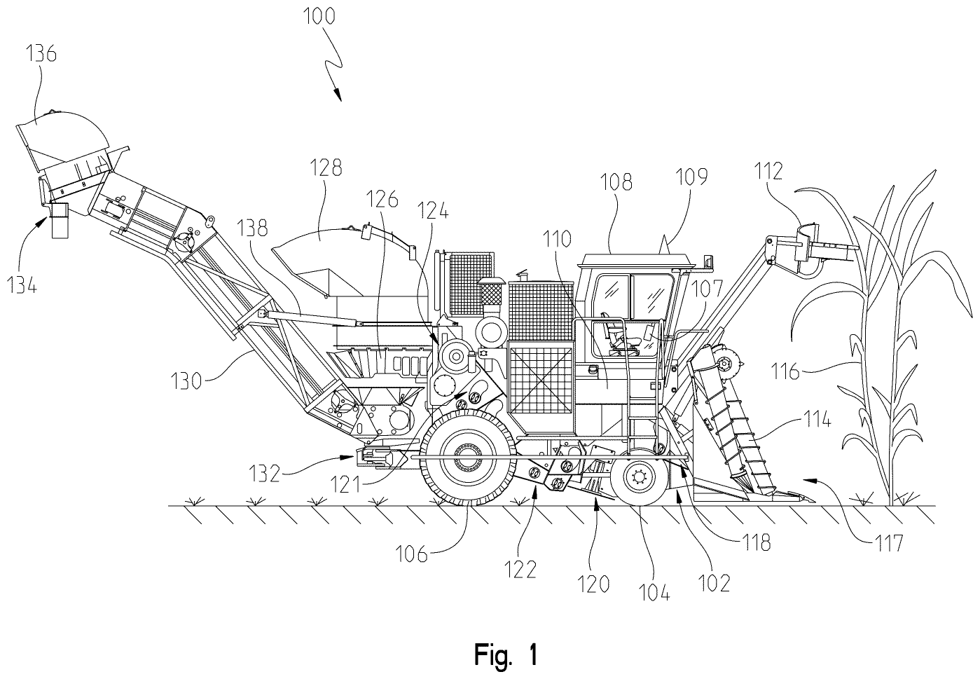

FIG. 1 illustrates a side view of a sugarcane harvesting machine 100. The front end of the machine 100 is facing to the right. Accordingly, certain left-side components of the machine 100 may not be visible in FIG. 1.

The machine 100 may include a main frame 102 supported on track assemblies (not shown) or wheels (i.e., a front wheel 104 and a rear wheel 106), with a cab 108 adapted to house an operator. The cab 108 may include a plurality of controls for controlling the operation of the machine 100. An antenna 109 is located on the cab 108. The antenna 109 is configured to receive and to transmit wireless signals to and from an externally located source of data information, such as is available over the web through a cloud system, to and from communication devices, such as a cellular communication device. i.e. cellular phone, or to and from a global navigation satellite system (GNSS). The GNSS may include a GPS system such as used in the United States, a Galileo system such as used in Europe, a GLONASS such as used in Russia, or a BeiDou system such as used in China. A user interface 107 is located in the cab 108 and includes one or more mechanical controls or one or more displays. The one or more displays may include a graphical user interface (GUI) displaying a status of different machine operating conditions, as well as providing a user touch screen for an operator to view the operating conditions, as well as providing for the selection and/or control of harvesting machine functions, devices, components, apparatus, systems, or implements.

An engine 110, or other power system, may supply power for driving the machine 100 along a field and for powering various driven components of the machine. In certain implementations, the engine 110 may directly power a hydraulic pump (not shown), and various driven components of the harvester may be powered by hydraulic motors (not shown) receiving hydraulic power from the hydraulic pump via an embedded hydraulic system (not shown).

A cane topper 112 may extend forward of the frame 102 in order to remove the leafy tops of sugarcane plants including cane stalks 116. Once topped, the sugarcane plants are captured by a header 117, which includes a set of crop dividers 114 (only the right-side divider shown in FIG. 1). The crop dividers 114 may then guide the remainder of the sugarcane toward internal components or mechanisms of the machine 100 for processing. As the sugarcane harvesting machine 100 moves across a field, plants 116 passing between the crop dividers 114 may be deflected downward by one or more knockdown rollers 118 before being cut near the base of the plants by a base cutter assembly 120 mounted on the main frame 102. The function of the knockdown rollers is to guide and incline a bundle of sugarcane to be cut, facilitating the base cutting operation and feeding the machine.

Rotating disks, guides, or paddles on the base cutter assembly 120 may further direct the cut ends of the plants upwardly and rearward within the harvester 100 toward a feeding mechanism such as successive pairs of upper and lower feed rollers 121. The feeding mechanism may be rotatably supported by a chassis 122 and may be rotatably driven by a hydraulic motor or other device (not shown) in order to convey the stalks toward a chopper drum module 124 for chopping into relatively uniform billets.

The chopper drum module 124 may include upper and lower chopper drums which may rotate in opposite directions around, respectively, parallel axes (not shown) in order to chop the passing stalks into billets and propel the billets into a cleaning chamber 126 at the base of a first or primary extractor 128. The first extractor 128 may utilize a powered fan to extract trash and debris from the cleaning chamber 126.

As also shown in FIG. 1, a loading conveyor or elevator system 130 may be provided at a rear portion of the harvester. The loading conveyor or elevator system 130 may include a forward end located at the bottom of the cleaning chamber 126, and the system may then convey the cleaned billets upward to a discharge location 134 near or below a second extractor 136. The billets may be discharged via the second extractor 136 into a trailing truck, cart, wagon, container, or other receptacle (not shown).

The elevator or conveyor system 130 may be coupled to a swing table or pivot bearing 132, as shown in FIG. 1. As such, the entire system 130 is capable of pivoting up to or about 180° to unload the billets from either side of the machine 100.

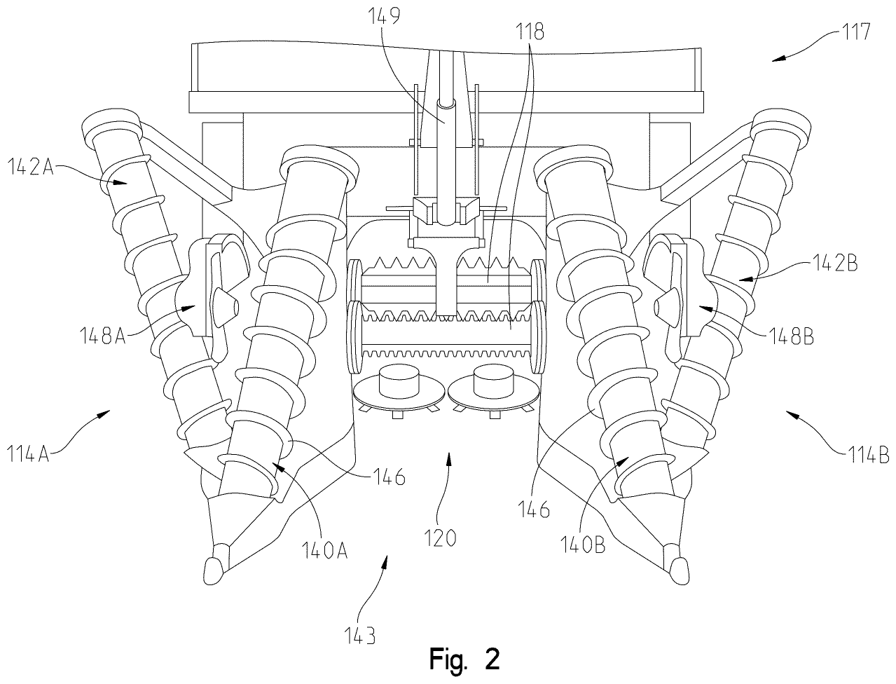

FIG. 2 illustrates the header 117 and crop dividers 114. A left crop divider 114A (as illustrated) includes a first inner scroll 140A and a first outer scroll 142A. A right crop divider 114B includes a second inner scroll 140B and a second outer scroll 142B. The left crop divider 114A is spaced from the second crop divider 114B and defines a space 143 through which cane stalks are received. Each of the first inner scroll 140A and second inner scroll 140B rotate in inward directions toward the knockdown roller 118. Each of the first outer scroll 142A and 142B rotate in an outward direction away from the knockdown roller 118. As the harvesting machine 100 moves along a field in a forward direction to harvest sugarcane, the cane topper 112 cuts the top of the sugarcane stalks 116. Once cut, the stalks 116 are directed to the space 143 between inner scrolls 140A and 140B. Sugarcane stalks that need to be raised to enter the space 143 contact rotating scrolls or spirals 146 located on the inner scrolls 140 and the outer scrolls 142. The raised sugarcane is directed toward the knockdown roller 118 by the inner scrolls 140 as well as by forward movement of the machine 100 moving in the forward direction.

While harvesting, the topper 112 removes leafy tops of the cane stalks 116. As the machine 100 moves forward, the cane stalks 116 are guided into the front of the machine 100 and positioned with respect to the header by the crop dividers 114. After topping of the cane stalks, the spirals 146 make a first contact with the cane stalk 116. The spirals 146 rotate inwards to lift and align the cane stalk 116 for butt-first feeding. Each of the spirals 146, which includes include a spiral wrap (an upward helix flight) are welded onto a cylindrical body and facilitate lifting of the cane stalk 116. The knockdown rollers 142 position the top of the cane stalks 116 away from the harvester to achieve the butt-first feeding of the cane stalk 116 as it enters the knockdown roller 118 and helps to align the stalk 116 within and along a row sugarcane plants. A first side knife 148A and a second side knife 148B located between one of the inner scrolls 140 and one of the outer scrolls 142 may optionally be turned on to cut sugarcane, vines, or other agricultural materials, stuck between the inner and outer scrolls. An actuator 149, such as a cylinder, is operatively connected to the topper 112 to adjust a position of the topper 112 with respect to the sugarcane.

During the machine's operation, the topper 112 cuts the top of the sugarcane stalks 116. Under ideal conditions, the sugarcane stalks 116 extend from the ground in a generally perpendicular direction. Under certain environmental conditions, such as wind and rain, the stalks 116 are impacted and may be moved to directions other than perpendicular. This condition results in what is known as lodged cane. During the harvester's operation, the topper cuts the top of the sugarcane, the crop dividers lift the lodged cane to a certain height, and the base cutter cuts the sugarcane roots which then conveys the sugarcane along a flow path from the crops dividers 114 to the knockdown rollers 118, to the base cutter 120, and to the feed rollers 121. The feed rollers 121 are located downstream of the base cutter assembly 120. When cane becomes lodged in the flow path, the harvesting operation becomes more difficult, and may result in a reduced amount of acceptable cane being harvested.

In some areas, planting of sugarcane mainly occurs on slopes and hills. Due to the influence of typhoons and the rainy climate, sugarcane is lodged at different degrees during the growth process. The configuration of the spirals on currently known model harvesters is designed to run at some ratio of engine speed. If the cane is lodged into an adjacent row of sugarcane, the lodged cane may not be separated from the other row, and the cane may be damaged. More importantly, this damage reduces the crop yield and may seriously affect the sugarcane's sprouting growth in the next year.

The failure to pick up stalks that have been lodged or have been knocked down, or stalks that have broken or been dropped during the gathering process, contributes to cane loss in this section of the harvester, for instance in the knockdown rollers 118. Likewise, aggressive bending of cane stalk during crop feeding may also result in stalk damage or breakage.

In practice it is difficult to measure these losses, because the material left in the paddock includes material that is dropped from all harvesting processes, including topper operations, header operations, knockdown roller operations, base cutter operations, cleaning operations, and other operations. Therefore, it is difficult to identify which specific harvesting process has damaged or contributed lost crop materials during harvesting. Additionally, ground losses are affected largely by the presentation of the crop to the harvester.-Ground losses may include crop losses due to the crop gathering process including losses at the base cutter, the crop divider, and the knockdown roller(s).

For instance, knockdown roller operations assist in front-end feeding of crop stalk by presenting the crop to the basecutter from the scrolls. To ensure efficient harvesting of crop, correct adjustment of the knockdown roller is important to reduce stool damage, soil in the sugarcane, and extractor loss from stalk splitting. Correct adjustment of knockdown rollers includes speed adjustment as well as height adjustment of the rollers above ground. Spacing between adjacent rollers may also be adjusted. Incorrect adjustment of knockdown roller may cause issues like clogging of material in the feed path and includes downtime to clean the roller or rollers which affects productivity. In many cases incorrect adjustment may cause aggressive feeding due to excessive rotation of the knockdown rollers.

During a harvesting operation, the lodged cane gradually rises along with the action of the lifting scrolls 146 and gathers in the middle of a crop row. With the operation of the crop divider, the lodged cane first contacts toes of the crop divider, is lifted to a certain height, and is then moved to a spiral plate under rotation of the scrolls. After passing through the knockdown rollers, the base cutter cuts the sugarcane roots and then conveys the cut stalk to the feed devices.

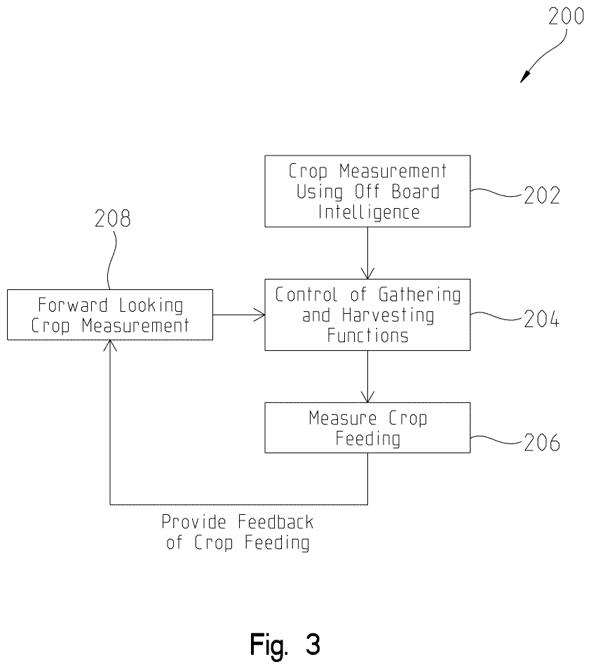

FIG. 3 illustrates one implementation of a control system 200 for a sugarcane harvester to harvest of sugarcane. The block diagram 200 of FIG. 3 includes an identification of or a measurement of sugarcane crop using crop information at block 202. The crop information identified at block 202 results from information provided by one or more crop imaging devices that are external to the harvesting machine 100. Such crop imaging devices are also known as off-board intelligence. Such crop imaging devices include, but are not limited to, imaging devices that provide image information of a field and its crop being harvested which is captured by the imaging device or devices. The image information may result from image processing which may extract useful information of the field being harvested. The useful information may include certain crop characteristics, that if known, may be used to improve or optimize guiding the bundle of sugarcane to be cut, knocking down the guided bundle of sugarcane, facilitating the base cutting operation, and feeding the cut sugarcane through the machine for billeting, delivery of billets, and billet storage.

The information provided by the crop measurement devices at block 202 is transmitted to a machine controller located on the harvesting machine 100. The machine controller provides for the control of crop gathering functions and harvesting functions at block 204. The machine controller, in one or more implementations executes or otherwise relies upon computer software applications, components, programs, objects, modules, or data structures, etc. Software routines, i.e. software, resident in the included memory, are executed in response to the signals received from the sensors or through CAN bus. In other implementations, the computer software applications are located in a memory internal to the controller or external to the controller, including the “cloud”. The executed software includes one or more specific applications, components, programs, objects, modules or sequences of program instructions typically referred to as “program code”. The program code includes one or more program instructions located in memory and other storage devices that execute the instructions that are resident in memory, which are responsive to other program instructions or machine settings generated by the system.

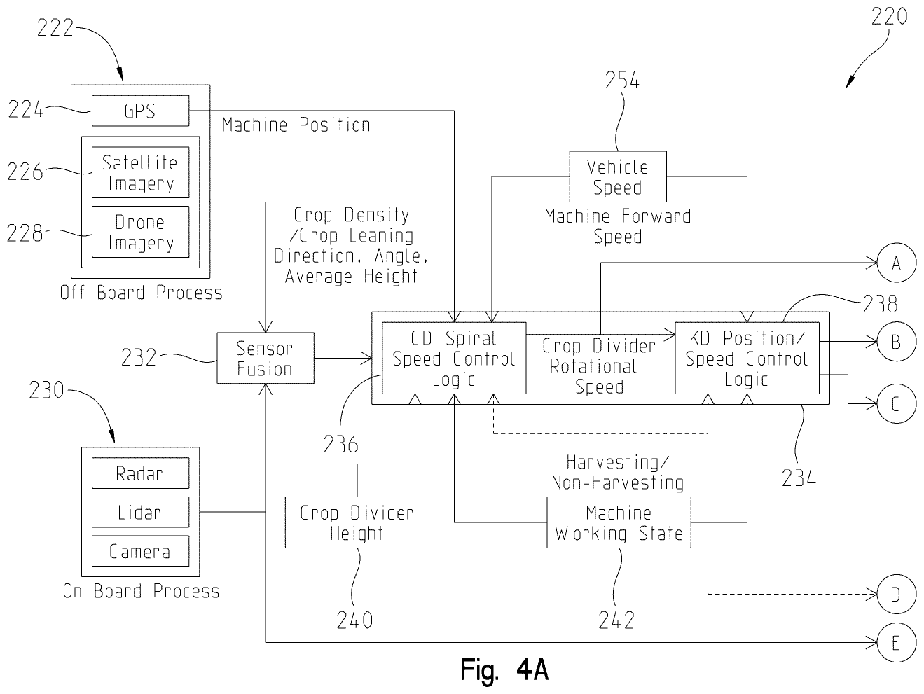

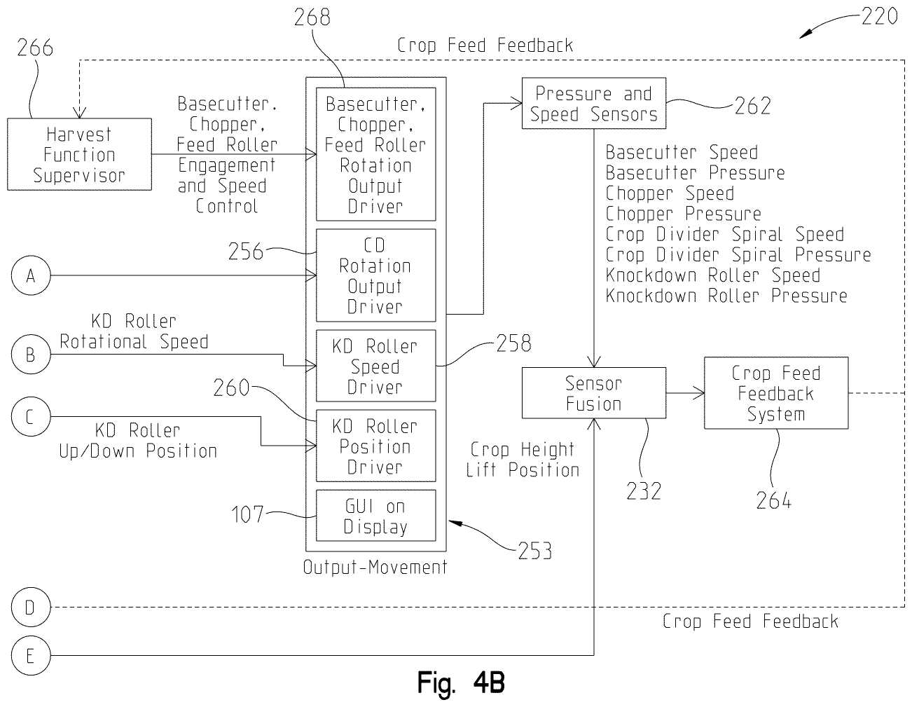

Upon receipt of the crop measurement information, the controller utilizes the received information in combination with the known harvesting function to transmit control instructions to each of the harvesting function provided by harvesting devices, systems, apparatus, or implements. For instance, rotational speeds and height of the crop dividers, and rotational speed and height or the knockdown rollers may be provided. Additional control instructions may be provided to other harvesting devices described herein and more specifically in FIG. 4.

As the harvesting machine 100 moves forward along a row to harvest sugarcane, the operating characteristics or performance of the harvesting devices are monitored by sensors at block 206. The sensors transmit information signals which may be used to adjust the operating characteristics of the devices. Since the crop measurement information includes crop data of crop to be harvested, for example, crop in front of the harvester but not yet being harvested, forward looking crop measurement information at block 208 is provided to the controller at bock 204 in combination with the sensed operating characteristics of the harvesting devices. The sensed operating characteristics are used in combination with the crop measurement information by the controller to adjust the operation of the harvesting devices.

FIG. 4 illustrates one implementation of a crop flow system 220 to provide improved and optimized harvesting of sugarcane by the harvester 100. Block 222 provides an exemplary implementation of the off board intelligence described in block 202 of FIG. 3. Off-board imaging devices may include a GPS system 224, satellite imagery 226 transmitted from satellites, and drone imagery 228 provided by drones. The off-board intelligence provides, in one or more implementations, crop information in the form of crop data. Such crop data includes but is not limited to crop density and may include cane stalk conditions such as crop leaning, crop direction, crop angle with respect to vertical, and average height. In addition, the off-board intelligence may provide machine 100 status information such as machine direction and machine speed.

The crop flow system 220 also relies on on-board processes or crop information identified by one or more on-board imaging systems at block 230, including, but not limited to radar, lidar, and video imaging devices, including cameras. The on board imaging systems may be located on the frame 102, the cab 108, the chassis 122, the cane topper 112, the header 117, or other locations.

As used herein, crop information, determined by either one or both of the off-board or on-board systems may include analog information, such as analog signals, or digital information, such as digital signals, that includes data that is stored, transferred, read, or used by networks, computers, controllers, processors, or other machines.

Information determined at block 222 and information determined at block 230 is transmitted to a controller located on the machine 100 or to an external computing system which processes the information, in the form of data at block 232 to “fuse” the data. The controller or external computing system processes, i.e. fuses, the data which may be merged, as understood by one skilled in the art, to provide an accurate model of the crop being harvested. As described herein, sensor fusion block 232, in one or more implementations, represents the fusion of the imaged data and/or sensor data at a computing system which may include a processor and a memory located on the machine 100 or an externally located computer system having a processor and a memory. As used herein data fusion includes a process of integrating data from multiple data sources to provide a set of data that provides a more complete and accurate representation of the captured information, than may be provided by any individual source of data.

Once the data has been fused at block 232, the fused data is transmitted to a machine controller 234. The machine controller 234 includes crop divider (CD) speed control logic 236 and knockdown (KD) roller position and/or speed logic 238. The CD speed control logic 236 receives some of or all of the fused data and also receives a crop divider height 240 and a machine working state 242. The crop divider height is identified by one or more sensors that transmit crop divider height information. In another implementation, the crop divider height is adjusted before the machine begins a harvesting operation. In different implementations, the machine controller 234 is located on the harvester 100 or at a location external to the harvester.

In one or more implementations, the crop divider spiral speed control logic of block 236 identifies one or more of crop density, lodging level/angle/average height, GPS position, crop divider height, machine speed, and machine working state.

With regard to crop density, the density of the crop being introduced to the header 117 is determined by on-board and/or off-board processing. The crop divider spiral rotational speed of block 236 is determined based on the density of crop which is being introduced to the header 117 and which may to be lifted at the time of introduction.

Lodging profile values of the crop being harvested are also identified. One or more of lodging levels, the angle of lodging, and the average height of the lodging of crop being input may be identified. The identified lodging values are determined by on-board or off-board processing. The identified lodging profile of the input crop is used to determine the crop divider spiral rotational speed.

The current location of the harvester within the field is also identified. In one implementation, a GPS position of the harvesting machine may be used to determine current position of the harvesting machine to determine crop density and lodging profile of the input crop at an identified field location as part of the off-board process.

The height of the crop divider may also be identified and used to determine rotational speed of the crop dividers 114. The crop dividers 114 generally follow ground contours while harvesting. By identifying ground contours and current row-farrow profile, the point of contact of input crop with respect to current crop divider height may be used to calculate spiral speed action, i.e. rotational speed of crop dividers, at the point of contact of the crop dividers to optimize the lifting action of the crop dividers.

Machine speed may also be used to determine crop divider rotational speed. For instance, if the header 117 encounters a same or similar crop lodging profile, but different harvesting machine forward speeds are identified, the spiral speed may be adjusted to provide a desired crop lifting action. Consequently, in one or more implementations, current crop lodge profiles are used to optimize CD spiral rotation speed when calculated and based on current harvester forward speed.

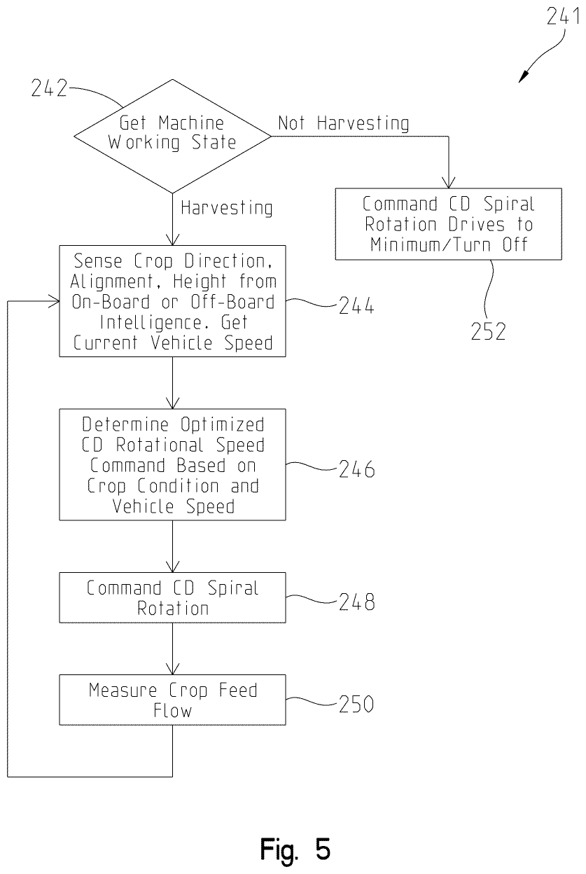

FIG. 5 shows one implementation of a process 241 for controlling spiral speed of the crop dividers. The machine working state is identified or accessed at the machine working state of block 242. The machine working state is identified and accessed while the machine 100 is harvesting sugarcane. At block 244, a condition of the crop being harvested is determined. This condition may include crop direction, alignment of the crop, and crop height from the on-board or off-board intelligence. At this block 244, current machine speed is also identified. Once crop condition and machine speed is obtained, an optimized CD rotational speed command based on crop condition and machine speed is determined at block 246. Once determined, the machine controller 234, using the optimized CD rotational speed command, is transmitted to the crop dividers to control the rotational speed thereof at block 248. While the crop dividers are rotating to raise the crop, the crop feed flow is measured at block 250. The measured value of crop flow is transmitted to block 244. If the machine working state at block 242 is not harvesting, the CD spiral rotation drives are commanded to rotate at a minimum speed or are turned off to not rotate at block 252.

The machine working state 242, in different implementations, provides a working state of the machine during a harvesting operation or during a non-harvesting operation. In one implementation, for instance, the harvesting state refers to machine working states where actual crops is being processed, gathered, cut, or transported in the harvester. For example, harvesting states may include a current rotational speed of the crop dividers 114 or a rotational speed of the knockdown rollers 118.

Machine working state 242 is also transmitted to KD speed control logic 238. In one implementation, the machine working state of the knockdown roller 118 is transmitted to the KD position/speed control logic 238. This state may include the rotational speed and the height of the knockdown roller 118 with respect to ground. The machine working state signal, which is transmitted to the CD speed control logic 236, identifies a current operating mode of machine including transport, unloading, manuaring, unplugging, and harvesting. In case of a working state of harvesting for example, CD spiral speed is commanded with calculated optimized speed. In case of non-working states like unloading, manuaring, transporting, CD spiral speed may be maintained to a minimum rotational speed, or the CD rotation can be turned off to save power.

Machine speed at speed block 254 is transmitted to both the CD spiral speed control logic 236 and to the KD Position/Speed control logic 238 of controller 234. This machine speed is the machine ground forward speed as the machine 100 moves along the rows being harvested. In one implementation, a ground speed sensor of block 254 provides a harvester forward speed signal to an input of the controller 234. The ground speed sensor may be operatively connected to a harvester transmission to provide a forward speed signal. Alternatively, radar or other types of ground speed sensors may be used to provide an indication of the forward speed.

In the case of the CD spiral speed control logic 236, the harvesting machine forward speed is used to adjust a rotation speed of the crop dividers 114. In one implementation, both of the lifting scrolls 140 and the divider scrolls 142 rotate at the same speed, although in different directions. In a further implementation, the lifting scrolls 140 and the divider scrolls 142 have rotational speeds that may be individually controlled to the same speed or to different speeds.

The CD spiral speed control logic 236 also receives a value of machine position transmitted by the off board intelligence of block 222. The CD spiral speed control logic 236, using the signal transmitted by the block 222, the signal provided by the block 240, and the signal provided by the machine working sate 242, generates and transmits a crop divider rotational speed signal to the KD position/speed control logic 238 and to an output movement controller 253 that includes a CD rotation output driver 256.

The KD position/speed control logic 238, upon receipt of the crop divider rotational speed signal and the machine working state 242, generates and transmits a KD roller rotational speed control signal to a KD roller speed driver 258 of the output movement controller 253. The KD position/speed control logic 238 also generates and transmits a KD roller up/down position control signal to a KD roller position driver 260 of the output movement controller 253. In one implementation, the values of each he signal transmitted by the drivers 256, 258, and 260 may be displayed on the display 107. In one implementation, a graphical user interface (GUI) provides for display of the values or each of the transmitted signals. In one or more implementations, features displayed by the GUI may include rotational speed and position of knockdown roller and crop divider, feedback camera image stream, feedback quality indicator, and system status.

As used herein the term “driver” refers to an electrical, mechanical, or hydraulic actuator that responds either directly or indirectly to a control signal to control, move, or adjust a position of an electrical or mechanical device, apparatus, or system.

Each of the signals transmitted by the CD rotation speed driver 256, the KD roller speed driver 258, and the KD roller position driver 260, are monitored by position and/or speed sensors 262 placed at an appropriate location on the machine 100. For instance, the operation of one or more devices may be sensed by the pressure and speed sensors. These sensors include but are not limited sensors for: basecutter speed of the basecutter, basecutter pressure of the basecutter, chopper speed of the chopper, chopper pressure of the chopper, crop divider spiral speed of the crop divider, crop divider spiral pressure of the crop divider, knockdown roller speed or the knockdown roller, and knockdown roller pressure or the knock down roller. Position sensors may also be provided to determine position of the one or more devices. For instance, the knockdown roller position may be monitored with the appropriate sensor. The height of the crop divider may also be monitored with the appropriate sensor.

Each of the rotation, speed, and/or position sensors 262 may provide signal outputs transmitted to the display 107 for viewing by an operator. The sensor signal outputs provide values which may displayed on the display 107 including but not limited to basecutter speed, basecutter pressure, chopper speed, chopper pressure, crop divider spiral speed, crop divider spiral pressure, knockdown roller speed, and knockdown roller pressure.

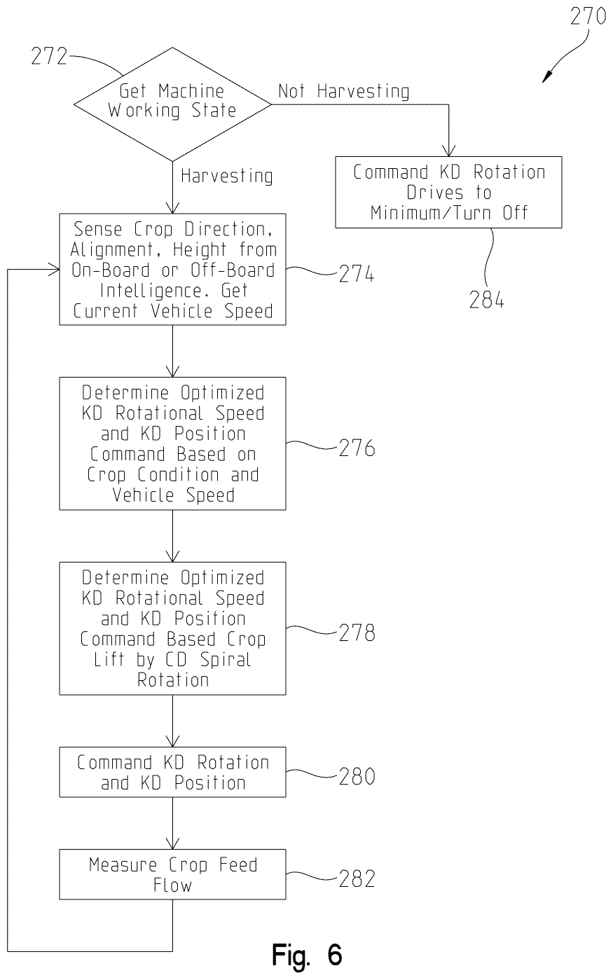

As seen in FIG. 6, one implementation of a process 270 for controlling KD rotational speed and KD height includes identifying machine working state at block 272. The machine working state is identified and accessed while the machine 100 is harvesting sugarcane. In some implementations, the machine working state determines current mode of the machine, such as harvesting, machine-like transport, unloading, manuaring, and unplugging. For harvesting, the KD speed is commanded with a calculated optimized speed.

After retrieving the machine working state at block 272, a condition of the crop being harvested is determined. This condition includes, crop direction, crop height from the on-board or off-board intelligence, and current machine speed at block 274. In one implementation, average crop lift height may be determined by current height of the crop after lift action. In another implementation, average crop lift height may be estimated by currently determined CD spiral speed based on experimental data. For the on-board process a camera, radar, or lidar, or imaging device mounded on the machine 100 may directly give feedback identifying crop lift height.

The optimized KD rotational speed and KD position command based on crop condition and machine speed is determined at block 276. Additionally, an optimized KD rotational speed and a KD position command based on crop lift and position command-based crop lift by CD spiral rotation is determined at block 278.

In one implementation, the KD up-down position and speed may to be optimized with respect to the current machine forward speed. Once optimized, the KD up-down position and speed may be determined with respect to the current forward speed. Once the commands at blocks 276 and 278 are determined, the KD rotation command is transmitted to the KD roller speed driver 258 and the KD position command is transmitted to the KD roller position driver 260 at block 280. Crop feed flow is measured at block 282 and the measured value is transmitted to block 274 and used to determine the condition of the crop being harvested. If the machine working state at block 272 is not harvesting, the KD roller speed driver 258 is either to rotated at a minimum speed or is turned off to not rotate to save power at block 284. The non-working states may include unloading, manuaring, transporting.

The sensor signal outputs 262 are transmitted to sensor fusion computing system 233 which fuses the sensor data 262, along with the onboard imaging system information 230, and the machine position information 222. As this information, in the form of data is being fused, it is transmitted to a crop feed feedback system 264. The crop feedback system 264 transmits feedback information in the form of data to the machine controller 234. The crop feedback system 264 also transmits the feedback information to a harvest function supervisor controller 266 that generates and transmits control signals to a plurality of output drivers. In one implementation, the output drivers include drivers for the basecutter assembly 120, the chopper 124, and the feed rollers 121 of FIG. 1. In one implementation, the onboard imaging system information 230 is generated during a harvesting operation, whereas the off-board imaging system information may be generated prior to a harvesting operation of during a harvesting operation.

The crop feedback system 264 which is coupled to the harvest function supervisor 266 controls engagement and speed for harvesting devices and their functions. These devices include the basecutter 120, the feed rollers 121, and the chopper 123. As crop is fed to the basecutter, the feed rollers, and the chopper, pressures applied to each of the devices when performing their function may vary, and the speed and/or rotation of each may be measured by sensors located thereon.

The basecutter speed and pressure information may indicate the “smoothness” of the harvesting operation and whether the basecutter experiences “choking” where harvested sugarcane, being fed into the basecutter, builds up and blocks, obstructs, or reduces the speed of the crop moving along the feed path and into the basecutter. The feed system also includes the feed rollers and the chopper. “Smoothness” of the harvested sugarcane moving through the feed system may be determined using one or more indicators of how efficiently the harvested sugarcane moves through the machine 100. In one or more implementations, “smoothness” may be identified based on whether and to what extent the speeds of rotation or the torque of output drivers changes over a period of time. For instance, if the identified torque of output drivers changes outside a range of torque over a predetermined period of time, the harvesting operation is considered to not be efficient, thereby reducing the amount of harvested crop being harvested or being damaged during harvesting. By identifying the conditions of speed and/or torque, the machine 100 may be adjusted while harvesting to improve the efficiency as well as the amount of undamaged harvested sugarcane.

For instance, the chopper speed and pressure information, identified by torque, may indicate consistent and smooth feeding of the crop being harvested, and moving thru the harvester. Efficient feeding may be indicated by smooth feeding and a lack of choking of the feed system. Crop gathering functions of speed and pressure may be monitored by one or more speed and/or pressure sensors mounted on the crop divider spiral speed control output drive 256 and/or the knockdown roller speed drive 258. Torque of the CD spiral while rotating should correlate to the smoothness of the feed and slipping of the crop at feed of the cane and at maximum position reached after crop lift. If excessive torque, for instance, is experienced by the CD rotation output driver 256, or instance, crop jamming may be indicated at the crop divider. The speed and pressure sensors of KD roller may indicate the consistent feeding, i.e. smoothness of feeding, as well indication choking or jamming. Torque measured by the KD roller may indicate a bending profile of sugarcane and speed of the KD roller may be optimized to avoid sugarcane damage due to bending of the stalks. Torque measured by KD roller may indicate aggressive feeding, i.e. a roller speed that exceeds the amount of sugarcane being fed to the KD rollers at a given harvesting speed. In this case the KD roller speed may be controlled to ensure smooth and constant feeding.

In addition to speed sensors, pressure sensors, or torque sensors, one or more crop feed flow sensors may be mounted on the machine 100 to observe and determine a stream of crop passing through feed rollers. In one implementation, imaging devices may identify and measure streamlines of the crop as it flows thru the feed train and the effectiveness of the crop dividers and scrolls in gathering and arranging the crop. Images, provided by the imaging devices, are transmitted to the controller 234 where the images are processed to identify crop feed flow. Based on an image analysis software resident at the controller, the controller identifies the state of crop feed flow to measure crop feed flow and to provide an indicator or value of the crop feed flow.

As described herein, the imaging devices include, but are not limited to, a mechanical, digital, or electronic device which may record and transmit still images or moving images. Digital imaging sensors are also contemplated. In other implementations, crop feed flow sensors include a mass flow impact sensor that provides an electrical signal representing crop feed flow. In one or more implementations, the imaging devices for the streamlines are considered to be part of the online imaging system. In one implementation, the imaging device located along the flow path identifies when flow of the sugar cane stalk is impeded, is reduced to an undesirable level, or is increased to a level that reduces flow rate along the path due to clogging, each of which may lead to a reduced harvesting capacity. The imaging devices may be located at harvester locations where crop feeding, crop cutting, and cut crop movement through the harvester. Such locations may include but are not limited to a forward perception of crop characteristics, which may include on top of cab or at down toward or around base cutter. For feedback sensing, the imaging devices may include inside a feed train chamber or below the cab such that input crop flow is visible. One or more cameras can be mounted on machine forward components such as the topper, camera can be pointed downward or rearward to observe the crop.

Average crop height lift position is also used by the crop feedback system 264 to provide efficient harvesting of the sugarcane being harvested. In one off-board-process, average crop lift height may be estimated by current determined CD spiral speed based on experimental data. In the on-board process, imaging systems including camera, radar, lidar mounded on the machine 100 may directly provide feedback of crop lift height. Control logic, such as provided by controller 234, may take all of the above inputs to determine smoothness of feeding. Feedback may be transmitted to the harvest function supervisor 266 to control engagement and/or speed of harvesting functions i.e., basecutter, feed roller, chopper. The harvest function supervisor 266 transmits control signals to output drivers of the basecutter, the chopper, and the feed roller at block 268. Additionally, crop divider spiral speed control and knockdown roller position/speed control logic may control engagement/speed of crop gathering functions i.e., crop divider height and rotation, KD roller position and rotation.

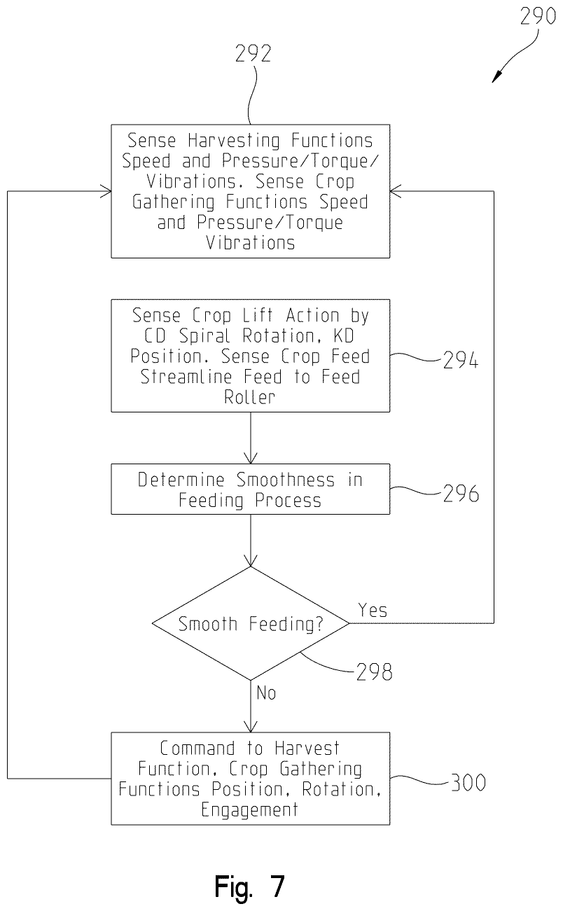

FIG. 7 illustrates a process 290 for a working mechanism of the control logic for the crop feedback system 264. At block 292, harvesting functions are sensed and identified which may include speed, pressure, torque, and vibrations. Crop gathering functions such as speed, pressure, torque, and vibrations are also sensed and identified. Harvesting function may include functions involved to cut cane like the basecutter, the chopper, and the feed roller. Gathering functions may include the crop divider and the knockdown roller. At block 294, crop lift action is determined and identified by the CD spiral rotation and the KD position. Crop feeding is sensed and identified to streamline feeding of cut crop to the feed roller.

After the sensing and identification functions made at blocks 292 and 294, the various systems as described above are monitored to determine the smoothness in the feeding process at block 296. If “smooth” feeding is determined at block 296, the process returns to block 292 to continue the harvesting process as determined at blocks 292, 294, 296, and 298. If, however, “smooth” feeding is not determined at block 298, crop feedback system 264 at block 300, generates and transmits one or more commands to adjust the harvesting function, and the crop gathering functions of position, rotation, and engagement of harvester devices.

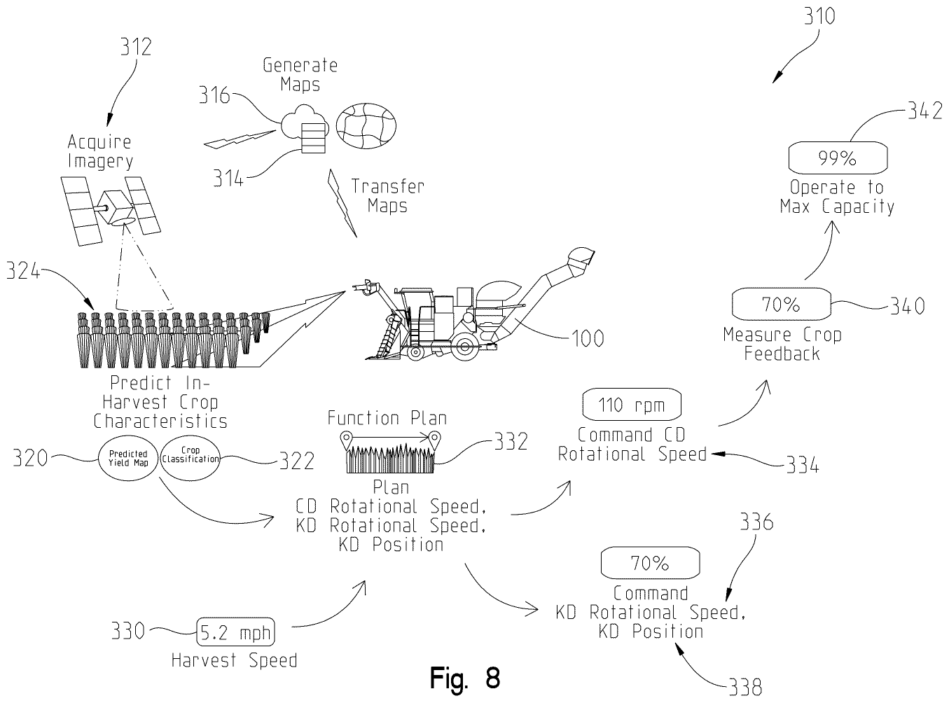

FIG. 8 illustrates one implementation of a process 310 for optimizing crop feeding for a sugarcane harvester based on crop conditions and harvesting speed. As described herein, as the harvester 100 moves along a row of sugarcane plants 116, the header 117 moves in a three-dimensional space due to the raising and lowering of the header 117 while the harvester moves along a row, which may not always be along a straight line direction. As the harvester moves in a forward direction, the harvester, the harvester machine functions, and the harvesting devices, respond to forward looking imaging devices mounted to the machine, or to an implement attached to the machine, i.e. onboard devices. These imaging onboard devices include, but are not limited to one or more of a stereo camera, a RADAR device, a LIDAR device, motion sensors, pressure sensors, or other types of sensors, each of which are mounted to the machine 100. These forward looking imaging devices determine crop density, lodging level/angle/height of the crop, and crop classification which includes standing crop or down crop.

The position of the crop being harvested with respect to the machine is also identified and is based on what is known as map based farming. In one or more implementations, the map based farming includes the use of externally located devices separate from the harvester 100, i.e. the off-board processes. This map based farming provides images that include the use of satellite imagery gathered by one or more satellites 312 employed throughout the growing season or imagery captured by an unmanned aerial vehicle (UAV), such as a drone (not shown) before harvesting. The satellite imagery from the satellite 312 or drone is transferred to a computing system 314, including a server, which generates one or more field maps. In one implementation, the images, identified herein as off board intelligence, is transmitted to a cloud system 316. In other implementations, the images are transmitted to an on premise computing system operated by a harvesting operation or an equipment manufacturer.

In one implementation that uses cloud based computing system 316, system 316 generates field maps that be based one of or both of the on-board crop information and the off-board crop information. In one implementation, the field maps generated by one of or both of the on-board processes and off-board processes are generated at discrete times. In other implementations, the field maps generated by one of or both of the on-board processes and off-board process are generated continuously. The generated field maps are subsequently transmitted to the harvester 100 which predictively detects crop density as the harvester 100 moves along the field. The predicted crop density includes a predictive field map 320 and/or a crop classification map 322. Crop characteristics 324, are provided in one or both the field map 320 and the crop classification map 322 which may include, crop density, lodging level/angle/height, and classification of the crop as a standing crop or a down crop. The predicted crop density may also include lodge level/sugarcane angle/sugarcane average height.

As the predicted harvested crop characteristics 324 are determined, a harvest speed 330 of the harvester 100 is identified, which in this exemplary implementation, is 52 miles per hour. The machine controller 234, based on the predicted harvested crop characteristic 324 and the harvest speed 330, generates an operational function plan 332, which includes machine commands providing for the selection and/or control of harvesting machine functions and devices. In one implementation, the machine commands includes CD rotational speed, KD rotational speed, and KD position. As the function plan 332 is generated, a CD rotational command 334 is generated and transmitted to one or more drivers to adjust the rotational speed of the crop divider 114. CD rotational speed 334 is adjusted in response to crop density and lodging Level/Angle/Average height with respect to the current harvest speed and the crop divider height. At this time, a KD rotational speed command 336 and a KD position command 338 are transmitted to one or more drivers that adjust a rotational speed of the knockdown rollers and a knockdown roller position. Control of the knockdown roller position is based on a change in crop level/crop angle/crop average height due to CD rotational action and harvesting speed. In this exemplary implementation, the command includes a value to adjust the KD rotational speed to 70% of its maximum value.

Once the CD rotational speed 334, KD rotational speed command 336, and a KD position command 338, are determined and transmitted to the appropriate drivers, the machine controller 234 identifies a crop feedback at crop feedback 340. The crop feedback 340 is determined by the amount of crop being fed to the harvester 100 based on one or more of a pressure sensor, a speed sensor mounted on harvesting functions, and a perception sensors utilizing sensor fusion. The pressure sensor would be connected between the pump and the motor. the speed sensor would be mounted on the output of the function, such as the scroll of the crop divider. The signals may be fused by combining the pressure and the speed signal to determine with a higher confidence the smoothness of the feeding based on conditions each sensor can detect with more confidence. Once determined, the harvester speed, the CD rotational speed, the KD rotational speed, and KD position are adjusted, if needed, to operate the harvester 100 at a maximum capacity to achieve an optimized harvesting operation based on crop characteristics and harvester speed. In one implementation, the machine controller 234 identifies a maximum harvesting machine operation capacity and adjusts the harvesting machine 100 to operate at ninety-nine (99) percent of capacity 342. The machine controller uses the feedback of crop feeding based on pressure sensors, speed sensors configured to identify speeds harvesting devices, and perception (imaging) sensors utilizing sensor fusion. That maximum harvesting machine operation capacity is identified to operate harvest gathering and harvesting functions at substantially close to the maximum capacity. As used herein, substantially means “to a great extent” which achieves an intended result of maximum capacity while avoiding damage to the crop being harvested and avoiding damage to the harvester while harvesting.

While implementations incorporating the principles of the present disclosure have been described hereinabove, the present disclosure is not limited to the described implementations. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A sugarcane harvester for harvesting a sugarcane crop having cane stalks, the sugarcane harvester comprising:
a frame;
a base cutter assembly couple to the frame and configured to cut the cane stalks at a base;
a header coupled to the frame, the header including a crop divider configured to position the cane stalks with respect to the header, wherein the crop divider is rotatable about a divider rotational axis;
a knockdown roller, coupled to the frame, wherein the knockdown roller is configured to direct the positioned cane stalk to the base cutter assembly, wherein the knockdown roller is rotatable about a roller rotational axis;
an imaging system configured to provide crop information of the sugarcane crop;
a controller operatively connected to the imaging system and configured to receive the crop information, wherein the controller transmits one or more control signals in response to the crop information to one or both of the crop divider and the knockdown roller.

2. The sugarcane harvester of claim 1 wherein the imaging system includes an off-board imaging device configured to provide off-board image information of the sugarcane crop and an on-board imaging device to provide on-board image information of the sugarcane crop, wherein the off-board image information and the on-board image information are fused to provide the controller with a crop density.

3. The sugarcane harvester of claim 2 wherein the off-board image information and the on-board image information are fused to provide the controller with conditions of the cane stalk prior to being positioned by the crop divider.

4. The sugarcane harvester of claim 3 further comprising one or more pressure sensors or one or more speed sensors operatively connected to one of or both of the crop divider or the knockdown roller, wherein each of the one or more pressure sensors provides pressure information and each the one or more speed sensors provides speed information.

5. The sugarcane harvester of claim 4 wherein the pressure information and the speed information is fused with the off-board image information and the on-board image information, and the fused information is transmitted to the controller to adjust operating conditions of the crop divider or the knockdown roller.

6. The sugarcane harvester of claim 5 wherein the one or more pressure sensors or one or more speed sensors are operatively connected to one of the basecutter or a chopper configured to cut the cane stalks into billets.

7. The sugarcane harvester of claim 1 wherein the crop information includes at least one of crop direction, alignment of the crop, and crop height.

8. The sugarcane harvester of claim 7 further comprising a machine speed sensor coupled to the controller, wherein the controller receives a speed signal provided by the machine speed sensor and the controller adjusts a speed of the crop divider in response to the speed signal.

9. The sugarcane harvester of claim 8 further comprising a crop feed flow sensor coupled to the controller, wherein the controller receives a crop feed flow signal provided by the crop feed flow sensor and the controller adjusts a speed of the crop divider in response to the crop feed flow signal.

10. The sugarcane harvester of claim 8 further comprising a crop feed flow sensor coupled to the controller, wherein the controller receives a crop feed flow signal provided by the crop feed flow sensor and the controller adjusts a speed of the knockdown roller in response to the crop feed flow signal.

11. A crop flow system for a sugarcane harvester harvesting a sugarcane crop having cane stalks, the crop flow system comprising:
a base cutter assembly configured to cut the cane stalks at a base of the cane stalks;
a header including a cane topper, and a first crop divider spaced from a second divider, wherein each of the first crop divider and the second crop divider are driven about a respective rotational axis by crop divider drivers;
a knockdown roller configured to direct the cane stalk to the base cutter assembly, wherein the knockdown roller is located downstream of the crop dividers along a flow path and is rotatable about a roller rotational axis;
feed rollers located downstream of the knockdown roller along the flow path;
an imaging system configured to provide crop information of the sugarcane crop;
a controller operatively connected to the imaging system and configured to receive the crop information, wherein the controller transmits one or more control signals in response to the crop information to a divider driver of the first crop divider or the second crop divider to adjust a rotational speed thereof, and to a roller driver of the knockdown roller to adjust a roller speed thereof.

12. The crop flow system of claim 11 wherein the imaging system includes an on-board imaging device to provide on-board image information of the sugarcane crop, wherein the on-board image information is received by the controller to adjust the rotational speed of the first and second crop divider and the roller speed of the knockdown roller.

13. The crop flow system of claim 12 wherein the on-board imaging system includes an imaging device at the feed roller configured to transmit a feed roller imaging signal to the controller to identify a flow rate of sugarcane stalk along the flow path.

14. The crop flow system of claim 13 wherein the controller, in response to the identified flow rate, adjusts the rotational speed of the first and second crop divider and the roller speed of the knockdown roller.

15. The crop flow system of claim 14 wherein the controller, in response to the identified flow rate, adjusts a position of the knockdown roller.

16. The crop flow system of claim 15 further comprising one or more pressure sensors or one or more speed sensors operatively connected to one of or both of the crop divider or the knockdown roller, wherein each of the one or more pressure sensors provides pressure information and each the one or more speed sensors provides speed information.

17. The crop flow system of claim 16 wherein the pressure information and the speed information is fused with the on-board image information, and the fused information is transmitted to the controller to adjust an operating condition of the crop divider or the knockdown roller.

18. A method of adjusting a flow rate of harvested sugarcane crop moving through a sugarcane harvester during a harvesting operation of a sugarcane crop, the method comprising:
imaging the sugarcane crop with an onboard imaging system and with an off-board imaging system to provide sugarcane crop condition information of the sugarcane crop to be harvested, wherein the sugarcane crop information includes at least one of sugarcane crop density, sugarcane crop alignment, and sugarcane height information;
identifying a divider rotational speed of a crop divider as the harvester harvests the sugarcane crop;
identifying a roller rotational speed of a knockdown roller as the harvester harvests the sugarcane crop;
identifying a crop flow of the harvested sugarcane along a crop flow path from the crop divider, to the knockdown roller, and to a feed roller; and
adjusting at least one of the identified divider rotational speed or the identified roller rotational speed based on the sugarcane crop information and the identified crop flow.

19. The method of clam 18 further comprising identifying a roller position of the knockdown roller and adjusting the roller position of the identified knockdown roller based on the sugarcane crop information and the identified crop flow.

20. The method of claim 19 further comprising identifying an amount of crop lift provided by the identified rotational speed of the crop divider and adjusting one of the roller rotational speed and the roller position based on the amount of crop lift.
